(19) United States
(12) Patent Application Publication
(10) Pub. No.: US 2015/0177595 A1
(43) Pub. Date: Jun. 25, 2015

(54) LIGHT-CONTROLLING DEVICE WITH REPLACEABLE OPTICAL FILTER

(71) Applicant: Te-Fan HO, Taipei City (TW)

(72) Inventor: Nai-Chi SHIN, Hsinchu City (TW)

(21) Appl. No.: 14/521,871

(22) Filed: Oct. 23, 2014

(30) Foreign Application Priority Data
Dec. 20, 2013 (TW) 102224099

(51) Int. Cl. G03B 11/00; G03B 15/06; G03B 7/00

(52) U.S. Cl. CPC G03B 11/00; G03B 7/00; G03B 15/06

(57) ABSTRACT

In a light-controlling device with replaceable optical filter, a slot seat has a slot, and the middle of the slot has a light-transmitting area. An optical filter is inserted into the slot and has a light-filtering member exposed to the light-transmitting area. The present invention directly extracts the optical filter in the slot whereby different color filters corresponding to external light are rapidly replaced without repeatedly disassembling the light-controlling device.

This application claims priority for Taiwan patent application no. 102224099 filed at Dec. 20, 2013, the content of which is incorporated by reference in its entirely.

### BACKGROUND OF THE INVENTION

1. Field of the Invention

The present invention relates to a light-controlling device for photography, particularly to a light-controlling device with replaceable optical filter for rapidly replacing different color filters.

2. Description of the Related Art

Presently, in order to make a theme figure or a theme object have a better hue or show the situation that people want when taking a photograph, a light-controlling device is installed in front of a flash, whereby the flash can emit natural light or the light matching the originality for designing pictures. Thus, no matter a photographer takes persons indoors or outdoors, the images formed by perfect light are captured.

In addition to emitting various light sources, the light-controlling device further has different color filters, which balances the difference of color temperature caused by different light sources. Color temperature is one of the important factors for affecting color in photography. Color temperature denotes the color combination of the light reflected by an object. Due to different light sources, the colors of the light reflected by the object are different. For example, the light of a cloudy day is inclined to blue, the light of a fluorescent lamp is inclined to green, and the light of sunset is inclined to yellow. Thus, when the color temperature shifts, the color filter is used to turn the color normal. Besides, the filter to change color temperature purposely creates the effect of warm light or cold light. Changing light can create different atmospheres in photography. As a result, the color of light plays a significant role in photography and greatly improves the possibility of photography.

However, the filter in the market is arranged between the light-controlling device and a lamp presently. When taking photographs, the filter has to be replaced in response to the color temperature of the environment. Specifically, the light-controlling device is uninstalled from the lamp, and then the filter is replaced. After replacing the filter, the light-controlling device is installed to the lamp. Over time, the repeatedly-disassembling behavior costs a lot of time and leads to damage to photographic equipments.

To overcome the abovementioned problems, the present invention provides a light-controlling device with replaceable optical filter, so as to solve the afore-mentioned problems of the prior art.

### SUMMARY OF THE INVENTION

A primary objective of the present invention is to provide a light-controlling device with replaceable optical filter. According to the color temperature of external light, different color filters corresponding to external light are directly rapidly replaced without repeatedly disassembling the light-controlling device.

Another objective of the present invention is to provide a light-controlling device with replaceable optical filter, which adjusts and balances the color temperature of external light forming images. Besides, the light-controlling device can change the color of light to generate the light of different color, whereby images are created more rapidly and more conveniently.

A further objective of the present invention is to provide a light-controlling device with replaceable optical filter. The light-controlling device has a simple structure and low failure.

To achieve the abovementioned objectives, the present invention provides a light-controlling device with replaceable optical filter, which comprises a slot seat having a slot, and the middle of the slot has a light-transmitting area. At least one optical filter is inserted into the slot and has a light-filtering member exposed to the light-transmitting area.

Compared with the traditional technology, the present invention has the following advantages: According to the color temperature of external light, different color filters corresponding to external light are directly rapidly replaced without repeatedly disassembling the light-controlling device. As a result, the present invention can adjust and balance the color temperature of external light forming images and the color of the light. Besides, the light-controlling device has a simple structure and low failure.

Below, the embodiments are described in detail in cooperation with the drawings to make easily understood the technical contents, characteristics and accomplishments of the present invention.

### BRIEF DESCRIPTION OF THE DRAWINGS

FIG. 1 is a perspective view showing a light-controlling device according to an embodiment of the present invention;

FIG. 2 is an exploded view showing the light-controlling device according to an embodiment of the present invention;

FIG. 3 is a perspective view showing a slot seat according to an embodiment of the present invention;

FIG. 4 is a perspective view showing an optical filter according to an embodiment of the present invention;

FIG. 5 is an exploded view showing the optical filter according to an embodiment of the present invention; and

FIG. 6 is a schematic view showing the usage of the light-controlling device according to an embodiment of the present invention.

### DETAILED DESCRIPTION OF THE INVENTION

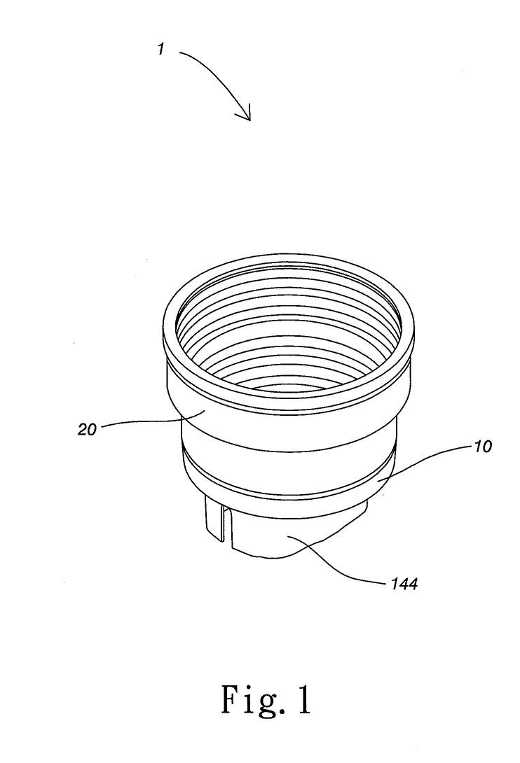

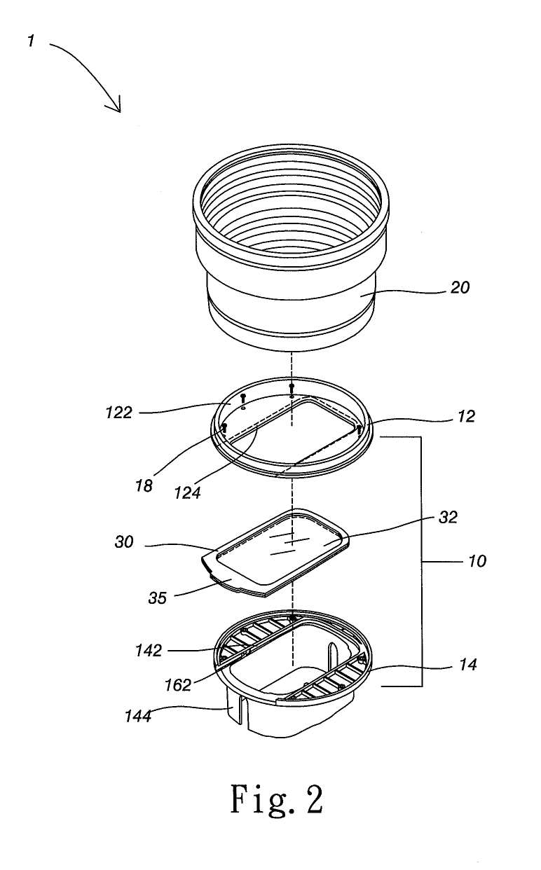

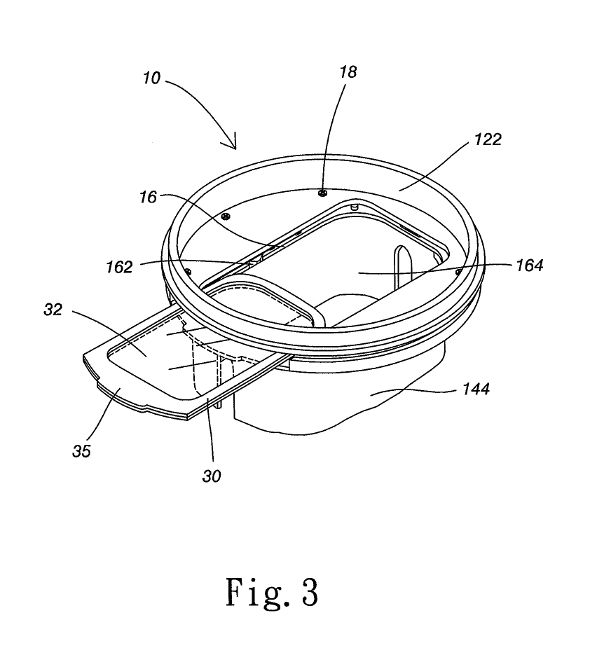

Refer to FIG. 1, FIG. 2 and FIG. 3. The present invention comprises a slot seat 10. The slot seat 10 comprises an upper slot cover 12 and a lower slot cover 14. The upper rim of the upper slot cover 12 is annularly provided with an installation member 122 to install a light-controlling component 20. In the embodiment, the light-controlling component 20 is exemplified by a lambency flash diffuser. Certainly, the light-controlling component 20 is realized with a radar reflector, a condenser, a sunshade, or a cellular light-controlling hood according the light source required by the images that a photographer wants. Additionally, the lower surface of the upper slot cover 12 is provided with a first hollow recess 124. The lower slot cover 14 is correspondingly combined with the upper slot cover 12. The upper slot cover 12 and the lower slot cover 14 are fixed by a plurality of fixed components 18 such as screws. The upper surface of the lower slot cover 14 has a second hollow recess 142, which connects with the first hollow recess 124 to form the slot 16. The lower surface of the lower slot cover 14 seat has a lamp installation member 144 to install the slot seat 10 to a lamp (not shown). As shown in FIG. 3, the upper slot cover 12 and the lower slot cover 14 are combined to form the slot seat 10, wherein each of two sides of the slot 16 formed by the first and second hollow recesses 124 and 142 is provided with at least one protruding member 162, and wherein the middle of the slot 16 has a light-transmitting area 164. An optical filter 30 can be inserted into the slot 16 and have a light-filtering member 32. When the optical filter 30 is inserted into the slot 16, the light-filtering member 32 is exposed to the light-transmitting area 164 of the slot 16. When the lamp installation member 144 is installed on a lamp (not shown), the light emitted by the lamp passes through the light-transmitting area 164 to appear the color of the light-filtering member 32. The optical filter 30 has an extracting member 35 emerging from the slot 16. When the optical filter 30 is replaced, the extracting member 35 is pulled so that the optical filter 30 is extracted from the slot 16.

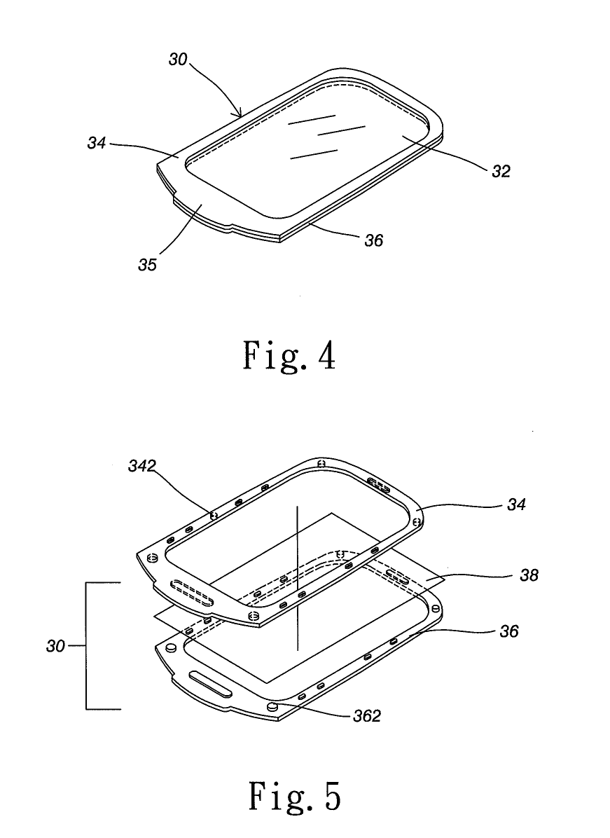

Refer to FIG. 3, FIG. 4 and FIG. 5. The optical filter 30 further comprises a first fixed frame 34 annularly provided with a plurality of recesses 342 and a second fixed frame 36 correspondingly arranged on the first fixed frame 34. The second fixed frame 36 is annularly provided with a plurality of bumps 362. The bumps 362 are locked to the recesses 342 of the first fixed frame 34. A color filter 38 is clamped between the first and second fixed frames 34 and 36. In addition to the outer edge of the color filter 38 clamped between the first and second fixed frames 34 and 36, the bumps 362 of the second fixed frame 36 pass through the color filter 38 whereby the color filter 38 is more stably fixed between the first and second fixed frames 34 and 36. Thus, the color filter 38 does not move outward. The first and second fixed frames 34 and 36 are trapezium fixed frames. The trapezium fixed frame has a narrower front end and a wider rear end forming the extracting member 35. The narrower front end is inserted into the slot 16. When the optical filter 30 is inserted into the slot 16, the front end of the optical filter 30 does not be blocked by the protruding member 162 in the slot 16, but the wider rear end of the optical filter 30 is blocked by the protruding member 162. As a result, the optical filter 30 is locked in the slot 16 without easily sliding out.

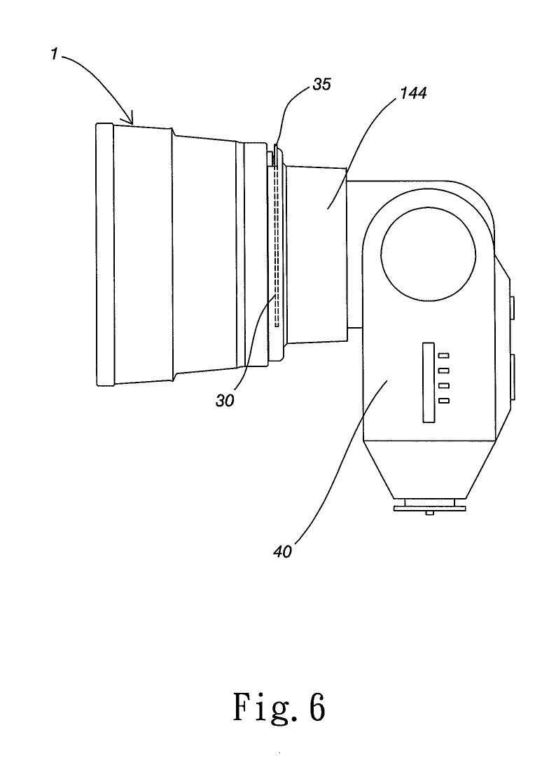

Refer to FIG. 3 and FIG. 6. FIG. 6 is a schematic view showing the usage of the embodiment. In the embodiment, the light-controlling device with replaceable optical filter 1 is installed on a lamp through the lamp installation member 144. The lamp is exemplified by a flash 40. The beam from the flash 40 passes through the light-filtering member 32 of the optical filter 30 to cast the light whose color is identical to the color of the optical filter 30. Accordingly, the color temperature of the external light forming images can be changed when taking photographs, whereby a photographer takes ideal photographs. The extracting member 35 of the optical filter 30 is directly pulled so that the optical filter 30 is extracted from the slot 16. Then, the optical filter 30 is replaced with another optical filter 30 of different color to change the color temperature of the images. Therefore, the optical filter 30 is only extracted from the slot 16 without painstakingly uninstalling the light-controlling device with replaceable optical filter from the flash 40, thereby replacing the optical filters 30 of different color.

In conclusion, according to the color temperature of external light, different color filters corresponding to external light are directly rapidly replaced without repeatedly disassembling the light-controlling device. As a result, the present invention can adjust and balance the color temperature of external light forming images. Besides, the light-controlling device has a simple structure and low failure.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A light-controlling device with replaceable optical filter comprising:
a slot seat having a slot, and a middle of said slot has a light-transmitting area; and
at least one optical filter inserted into said slot and having a light-filtering member exposed to said light-transmitting area.

2. The light-controlling device with replaceable optical filter according to claim 1, wherein an upper rim of said slot seat is annularly provided with an installation member to install a light-controlling component.

3. The light-controlling device with replaceable optical filter according to claim 2, wherein said light-controlling component is a lambency flash diffuser, a radar reflector, a condenser, a sunshade, or a cellular light-controlling hood.

4. The light-controlling device with replaceable optical filter according to claim 1, wherein said optical filter further comprises:
a first fixed frame;
a second fixed frame correspondingly arranged on said first fixed frame; and
a color filter clamped between said first and second fixed frames.

5. The light-controlling device with replaceable optical filter according to claim 4, wherein said first and second fixed frames are trapezium fixed frames.

6. The light-controlling device with replaceable optical filter according to claim 4, wherein said first fixed frame is annularly provided with a plurality of recesses; and said second fixed frame is annularly provided with a plurality of bumps, and said bumps are locked to said recesses of said first fixed frame.

7. The light-controlling device with replaceable optical filter according to claim 1, wherein each of two sides of said slot is provided with at least one protruding member to lock said light-filtering member to said slot.

8. The light-controlling device with replaceable optical filter according to claim 1, wherein a lower surface of said slot seat has a lamp installation member to install said slot seat to a lamp.

9. The light-controlling device with replaceable optical filter according to claim 8, wherein said slot seat further comprises:
an upper slot cover with an upper rim thereof provided with an installation member and a lower surface thereof having a first hollow recess; and
a lower slot cover correspondingly combined with said upper slot cover, and an upper surface of said lower slot cover has a second hollow recess, which connects with said first hollow recess to form said slot.

10. The light-controlling device with replaceable optical filter according to claim 9, wherein said slot seat further comprises a plurality of fixed components to fix said upper slot cover and said lower slot cover.

11. The light-controlling device with replaceable optical filter according to claim 10, wherein said fixed components are screws.

12. The light-controlling device with replaceable optical filter according to claim 1, wherein said optical filter further comprises an extracting member emerging from said slot to replace said optical filter.
